(19) United States
(12) Patent Application Publication
(10) Pub. No.: US 2023/0120256 A1
(43) Pub. Date: Apr. 20, 2023

(54) TRAINING AN ARTIFICIAL NEURAL NETWORK, ARTIFICIAL NEURAL NETWORK, USE, COMPUTER PROGRAM, STORAGE MEDIUM AND DEVICE

(71) Applicant: Robert Bosch GmbH, Stuttgart (DE)

(72) Inventor: David Terjek, Marcali (HU)

(21) Appl. No.: 17/915,210

(22) PCT Filed: Jun. 23, 2021
(86) PCT No.: PCT/EP2021/067105

§ 371 Date: Sep. 28, 2022

(30) Foreign Application Priority Data
Jun. 24, 2020 (DE) 10 2020 207 792.4

(51) Int. Cl. G06N 3/08; G06N 3/047

(52) U.S. Cl. CPC G06N 3/08; G06N 3/047

(57) ABSTRACT

A method for training an artificial neural network, in particular a Bayesian neural network, in particular of a recurrent artificial neural network, in particular a VRNN, to predict future sequential time series in time steps as a function of past sequential time series to control an engineering system, using training data sets, a step being provided of adapting a parameter of the artificial neural network as a function of a loss function, the loss function comprising a first term, which includes an estimate of a lower bound (ELBO) of the distances between a prior probability distribution (prior) over at least one latent variable and a posterior probability distribution (inference) over the at least one latent variable, wherein the prior probability distribution (prior) is independent of future sequential time series.

### FIELD

The present invention relates to a method for training an artificial neural network. The present invention further relates to an artificial neural network trained using the training method according to the present invention and to the use of such an artificial neural network. Furthermore, the present invention relates to a corresponding computer program, a corresponding machine-readable storage medium and a corresponding device.

### BACKGROUND INFORMATION

A key factor in autonomous driving is behavior prediction, which relates to the problematic area of forecasting the behavior of road users (such as for example vehicles, cyclists and pedestrians). For an at least partly autonomous vehicle, it is important to know the probability distribution of possible future trajectories of the road users around it, in order to be able to plan, in particular plan movements, safely such that the at least partly autonomous vehicle is controlled in such a way as to keep the risk of a collision to a minimum. Behavior prediction may be associated with the more general problem of predicting sequential time series, a problem which may in turn be considered a case of generative modeling. Generative modeling relates to the approximation of probability distributions, e.g. to learn a probability distribution in data-controlled manner with the assistance of artificial neural networks (ANNs); the target distribution is represented by a data set consisting of a number of random samples from the distribution, and the ANN is then trained to output distributions which correspond with a high level of probability to the data samples, or to produce samples which resemble those of the training data set. The target distribution may be unconditional (e.g. for image generation) or conditional (e.g., for a prediction where the distribution of the future states is dependent on the past states). In the case of behavior prediction, the object is to predict a specific number of future states as a function of a specific number of past states, for example to predict the probability distribution of the positions of a given vehicle in the next 5 seconds, as a function of the positions of the vehicle over the past 5 seconds. Assuming a temporal sampling rate of 10 Hz, this would mean that 50 future states are to be predicted as a function of the knowledge of 50 past states. One possible approach to modeling such a problem is modeling of the time series with a recurrent artificial neural network (RNN) or a one-dimensional convolutional neural network (1D-CNN), wherein the input is the sequence of past positions and the output a sequence of distributions of the future positions (e.g. in the form of the mean and parameters of a two-dimensional normal distribution).

Models with deep latent variables such as the Variational Autoencoder (VAE) are widely used tools for generative modeling using artificial neural networks. Conditional VAE (CVAE) may in particular be used to learn conditional distributions (i.e. a distribution of x conditioned by y) by optimizing the following estimate of the lower bound (Evidence Lower Bound; ELBO) to a logarithmic distribution. Below, the lower logarithmic probability bound is optimized:

log p(x|y)≥ [symbol] _{q(z|x, y)}[log p(x|y,z)]−D_{KL}(q(z|x, y)∥p(z|y))

By maximizing this lower bound, the underlying probability distribution will also be higher. By applying the method of Maximum Likelihood Estimation (MLE), this formula may be used as a training object for the artificial neural network to be trained. To this end, three components need to be modeled by the network:
1) The prior probability distribution (prior): p(z|y) represents the probability distribution of the latent variable z conditional on variable y.
2) The posterior probability distribution (inference): q(z|x,y) here represents the probability distribution of the latent variable z conditional on the variable y and the observable output x.
3) The further probability distribution (generation): p(x|y,z) here represents the probability distribution of the observable output x conditional on variable y and latent variable z.

If an RNN is used as the artificial neural network, the hidden states have additionally to be implemented, which represent a summary of the past time steps as a condition for the prior, inference and generation probability distributions.

These components have to be implemented in such a way as to allow sampling and a analytical calculation of the Kullback-Leibler divergence. This is the case, for example, for learned normal distributions (artificial neural networks to this end typically output a vector composed of the mean and variance parameters). The conditional probability distribution to be learned is p(x|y), which may be extended to p(x|y,z)p(z|y), in order to use latent variable z. At training time, the two variables x and y are known. At inference time, only variable y is still known.

A number of models for sequential latent variables have been published for modeling time series, some of which are listed below:

1) RNN based:
STORN: https://arxiv.org/abs/1411.7610
VRNN: https://arxiv.org/abs/1506.02216
SRNN: https://arxiv.org/abs/1605.07571
Z-Forcing: https://arxiv.org/abs/1711.05411
Variational Bi-LSTM: https://arxiv.org/abs/1711.05717

2) 1D-CNN based:
Stochastic WaveNet: https://arxiv.org/abs/1806.06116
STCN: https://arxiv.org/abs/1902.06568

All of these models are based on using a CVAE for each time step. The conditional variable here represents a summary of the observable and latent variables of the previous time steps, for example using the hidden state of an RNN. To this end, these models require an additional component compared with a conventional CVAE in order to implement the summary. In this respect, it may be the case that the prior probability distribution provides the future probability distribution of the latent variable conditional on the past observable variable, while the inference probability distribution provides the future probability distribution of the latent variable conditional on the past and also the currently observable variable. In this way, the inference probability distribution “cheats” by knowing the current observable variable, which is unknown for the prior probability distribution. The target function for a time ELBO with a sequence length of T is indicated below:

$${𝔼}_{q ( {Z}_{\leq T} \vert {x}_{\leq T} )} [ {\sum }_{t = 1}^{T} ( - KL ( q ( {z}_{t} \vert {x}_{\leq t} , {z}_{< t} ) ‖ p ( {z}_{t} \vert {x}_{< t} , {z}_{< t} ) ) + log p ( {x}_{t} \vert {z}_{\leq t} , {x}_{< t} ) ) ]$$

This target function was defined for VRNN, but it has been shown that other variants can also use it, optionally with corresponding additional terms.

### SUMMARY

The present invention is based on the recognition that, to train an artificial neural network or a system of artificial neural networks to predict time series, the one prior probability distribution (prior) used for the loss function is based on information which is independent of the training data of the time step to be predicted or the prior probability distribution (prior) is based solely on information prior to the time step to be predicted.

The present invention is further based on the recognition that the artificial neural networks or systems of artificial neural networks may be trained using a generalization of the estimate of a lower bound (Evidence Lower Bound; ELBO) as a loss function.

This makes it possible to make predictions of time series over any desired prediction horizon h (i.e. any desired number of time steps) without a progressive loss in prediction quality, and therefore with improved prediction quality.

This results in a marked improvement in control being possible on application for control of machines, in particular at least partly autonomous machines, such as autonomous vehicles.

The present invention therefore provides a method for training an artificial neural network for predicting future sequential time series in time steps as a function of past sequential time series for controlling an engineering system. The training is in this case based on training data sets.

According to an example embodiment of the present invention, the method in this case comprises a step of adapting a parameter of the artificial neural network to be trained as a function of a loss function.

The loss function in this case comprises a first term, which includes an estimate of a lower bound (ELBO) of the distances between a prior probability distribution (prior) over at least one latent variable and a posterior probability distribution (inference) over the at least one latent variable.

In the training method according to an example embodiment of the present invention, the prior probability distribution (prior) is independent of future sequential time series.

In this case, the training method is suitable for training a Bayesian neural network. The training method is also suitable for training a recurrent, artificial neural network, in particular for a Virtual Recurrent Neural Network (VRNN) according to the related art outlined above.

According to one example embodiment of the method of the present invention, the prior probability distribution (prior) is not dependent on the future sequential time series.

According to an example embodiment of the present invention, the future sequential time series do not enter into the determination of the prior probability distribution (prior). In accordance with an example embodiment of the present invention, although the future sequential time series do enter into determination of the prior probability, the probability distribution is substantially independent of these time series.

According to one example embodiment of the method of the present invention, the lower bound (ELBO) is estimated according to the rule below using the following loss function.

log p(x_{t+1 . . . t+h}|x_{1 . . . t})

≥ [symbol] _{q(z}_{_{1 . . . t+h}}_{|x}_{_{1 . . . t+h)[log}} p(x_{t+1 . . . t+h}|x_{1 . . . t}, z_{1 . . . t+h)]}

−D_{KL}(q(z_{1 . . . t+h}|x_{1 . . . t+h})||p(z_{1 . . . t+h}|x_{1 . . . t}))

In the above:

p(x_{t+1 . . . t+h}|x_{1 . . . t}) represents the target probability distribution over the observable variables, x_{t+. . . t+h}, the future time steps up to a horizon, h conditional on the observable variables of the past time steps, x_{1 . . .t};

q(z_{1 . . . t+h}|x₁ . . . t+h) represents the inference, i.e., the posterior probability distribution (inference) over the latent variable, z₁ . . . t+h, over the entire observation period, i.e. for the past time step, 1 . . . t and the future time steps up to a horizon h, t+1 . . . t+h conditional on the observable variables over the entire observation period, x_{1 . . . t+h};

p(x_{t+1 . . . t+h}|x_{1 . . . t}, z_{1 . . . t+h}) represents the generation, i.e. a probability distribution over the observable variables of the future time steps up to a horizon h, xₜ₊₁ . . . t+h, conditional on the observable variables of the past time steps x_{1 . . . t} and the latent variables, z_{1 . . . t+h}, over the entire observation period, t+1 . . . t+h;

p(z_{1 . . . t+h}|x_{1 . . . t}) represents the prior, i.e., the prior probability distribution (prior) over the latent variables, z_{1 . . . t+h}, over the entire observation period conditional on the observable variables of the past time steps, x_{1 . . . t}.

The rule corresponds to an estimate of a lower bound (ELBO) according to the Conditional Variational Encoder (CVAE) as in the related art, with

x=x_{t+1 . . . t+h} being the observable states after time step t, i.e. future states;

y=x_{1 . . .t} being the observable states up to and including time step t, i.e., the known states;

z=z_{1 . . . t+h} being the hidden states of the artificial neural network

A further aspect of the present invention is a computer program, which is set up to carry out all the steps of the method according to the present invention.

A further aspect of the present invention is a machine-readable storage medium, on which the computer program according to the present invention is stored.

A further aspect of the present invention is an artificial neural network trained using a method for training an artificial neural network according to the present invention.

The artificial neural network may in this case be a Bayesian neural network or a recurrent artificial neural network, in particular for a VRNN according to the related art outlined above.

A further aspect of the present invention is the use of an artificial neural network according to the present invention to control an engineering system.

For the purposes of the present invention, the engineering system may comprise, inter alia, a robot, a vehicle, a tool or a machine tool.

A further aspect of the present invention is a computer program, which is set up to carry out all the steps of the use of an artificial neural network according to the present invention to control an engineering system.

A further aspect of the present invention is a machine-readable storage medium, on which the computer program according to an aspect of the present invention is stored.

A further aspect of the present invention is a device for controlling an engineering system, which is set up to use an artificial neural network according to the present invention.

Example embodiments of the present invention are explained in greater detail below based on the figures.

### BRIEF DESCRIPTION OF THE DRAWINGS

FIG. 1 shows a flowchart of one example embodiment of the training method according to the present invention.

FIG. 2 shows a processing diagram for a sequential data series for training an artificial neural network according to an example embodiment of the present invention.

FIG. 3 shows a processing diagram for input data using an artificial neural network according to the related art.

FIG. 4 shows a processing diagram for input data using an artificial neural network trained using the training method according to an example embodiment of the present invention.

FIG. 5 shows a detail of the processing diagram for input data using an artificial neural network trained using the training method according to an example embodiment of the present invention.

FIG. 6 shows a flowchart of an iteration of an example embodiment of the training method according to the present invention.

### DETAILED DESCRIPTION OF EXAMPLE EMBODIMENTS

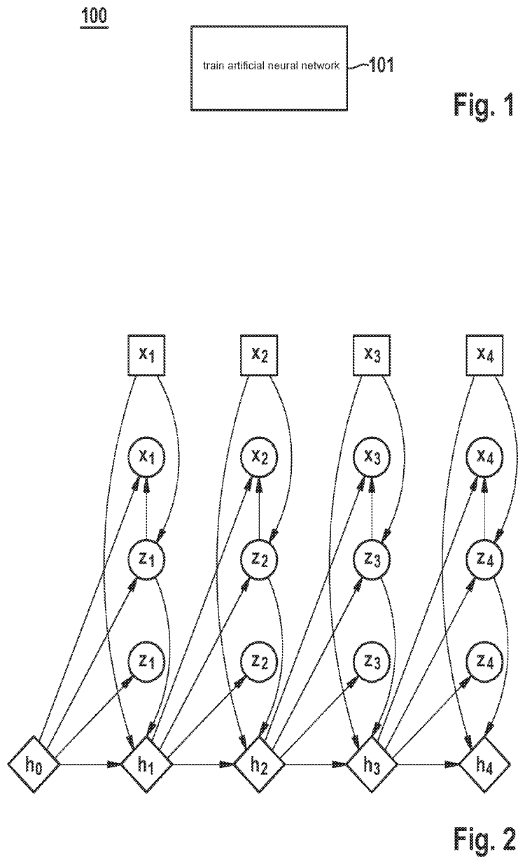

FIG. 1 shows a flowchart of one embodiment of the training method 100 according to the present invention.

In step 101, an artificial neural network is trained, using training data sets (x₁ to xₜ+h), to predict future sequential time series (xₜ₊₁ to xₜ+h) in time steps (t+1 to t+h) as a function of past sequential time series (x₁ to xₜ) to control an engineering system, a step being provided of adapting a parameter of the artificial neural network as a function of a loss function, wherein the loss function comprises a first term, which represents an estimate of a lower bound (ELBO) of the distances between a prior probability distribution (prior) over at least one latent variable (z₁ to zₜ+h) and a posterior probability distribution (inference) over the at least one latent variable (z₁ to zₜ+h).

The training method is distinguished in that the prior probability distribution (prior) is independent of future sequential time series (xₜ₊₁ to x_{t+h).}

FIG. 2 shows a processing diagram of a sequential data series (x₁ to x₄) for training an RNN according to the related art.

In the diagram, squares denote ground truth data. Circles denote random data or probability distributions. Arrows leaving a circle denote taking (sampling) a sample, i.e., a random item of data, from the probability distribution. Rhombuses denote deterministic nodes.

The diagram shows the state of the calculation after processing of the sequential data series (x₁ to x₄).

In time step t, firstly the prior probability distribution (prior) is determined as a conditional probability distribution p(zₜ|hₜ₋₁) of the latent variable zₜ conditional on the summary of the past represented in the hidden state hₜ₋₁ of the RNN.

Furthermore, the posterior probability distribution (inference) is determined as a conditional probability distribution q(zₜ|hₜ₋₁, xₜ) of the latent variable zₜ conditional on the summary of the past represented in the hidden state hₜ₋₁ of the RNN and the item of data xₜ, assigned to time step t, of the sequential time series (x₁ to x₄).

Based on the sample zₜ of the posterior probability distribution (inference), the further conditional probability distribution (generation) p(xₜ|hₜ₋₁, zₜ) of the observable variable xₜ is further determined conditional on the summary of the past represented in the hidden state hₜ₋₁ of the RNN and the sample zₜ.

A sample xₜ from the further probability distribution (generation) and the item of data xₜ, assigned to time step t, of the sequential time series (x₁ to x₄) are then supplied to the RNN, in order to update the hidden state hₜ, assigned to time step t, of the RNN.

The hidden states hₜ, assigned to a time step t, of the RNN represent the states of the model of the past time steps <t according to following rule:

hₜ=f(x_{≤t}, z_{≤t})

The function f should be selected according to the model used, i.e., according to the artificial neural network used, i.e., according to the RNN used. Selection of the suitable function falls within the specialist knowledge of a relevant person skilled in the art.

The initial hidden state h₀ of the RNN may be selected as desired and may for example be h₀=0.

Using the further probability distribution (generation) and the item of data xₜ, assigned to time step t, of the sequential time series (x₁ to x₄), the “likelihood” part of the estimate of the lower bound (ELBO) can be estimated according to the present invention. To this end, the following rule may be used:

[symbol]

_{z}_{ₜ}_{˜q(z}_{ₜ}_{|h}_{_{h−1}}_{, x}_{ₜ}) log p(xₜ|hₜ₋₁, zₜ)

Using prior probability (prior) and posterior probability (inference) over the hidden states hₜ, assigned to time step t, of the RNN, the KL divergence part of the lower bound (ELBO) can be estimated. To this end, the following Kullback-Leibler divergence (KL divergence) rule can be used:

[symbol]

_{KL}(p(xₜ|hₜ₋₁, zₜ)∥p(zₜ|hₜ₋₁))

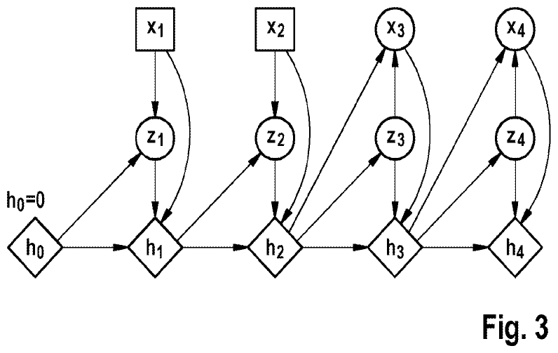

FIG. 3 shows a processing diagram for input data during use of an artificial neural network.

In the diagram shown, the data of the two future time steps x₃, x₄ are predicted on the basis of two items of input data x₁, x₂, which constitute data from the two past time steps. The diagram indicates the state after prediction of the two future time steps x₃, x₄.

When processing the input data x₁, x₂ for predicting future data of the time series x₃, x₄, first of all the latent variables zₜ may be derived from the posterior probability distribution (inference) conditional on the hidden state hₜ₋₁ assigned to the previous time step t−1 and on the input item of data xₜ assigned to the current time step.

The input data xₜ and the derived variable zₜ from the posterior probability distribution (inference) are then used to update the hidden state hₜ assigned to the current time step t.

As soon as the prediction data x₃, x₄ are needed to update the respective hidden states hₜ, the latent variables z₃ and z₄ can only be derived from the prior probability distribution (prior) over the hidden state hₜ₋₁. Samples from the prior probability distribution (prior) may then be used to derive the prediction data xₜ assigned to the current time step t using the further probability distribution (generation) conditional on the latent variable zₜ assigned to the current time step and the hidden state hₜ₋₁ assigned to the preceding time step t−1.

Then, to update the hidden state hₜ assigned to the current time step t, the latent variables zₜ from the prior probability distribution (prior) and the prediction data xₜ from the further probability distribution (generation) are used.

This fundamental change when updating the hidden states hₜ leads to a weak long-term forecast performance.

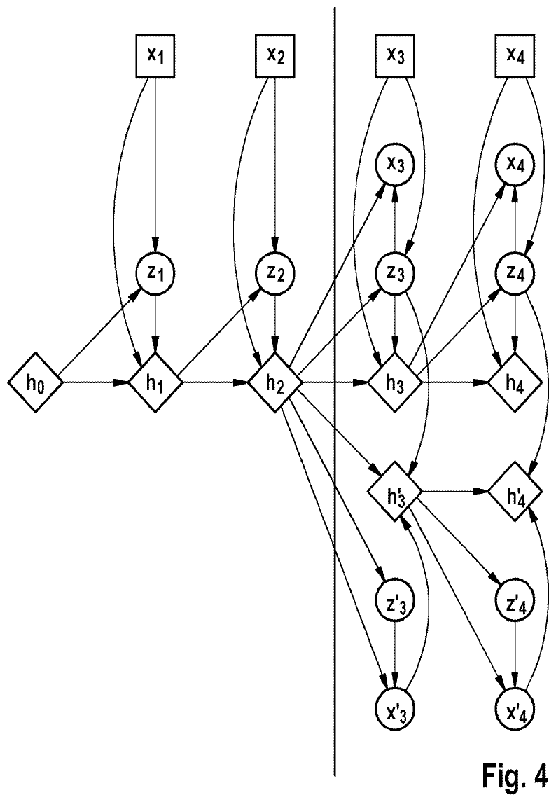

FIG. 4 shows a processing diagram for input data using an artificial neural network trained using the training method according to the present invention.

The central difference relative to processing using an artificial neural network trained according to a related art method lies in the fact that the prior probability distribution (prior) over the latent variables zᵢ in a time step i>t remain dependent only on the variables x₁ to xₜ observed until time step t and no longer, as in the related art, on the observable variables x₁ to xᵢ₋ⱼ of all previous time steps. Thus, the prior probability (prior) remains dependent only on the (known) data of the sequential data series x₁ to xₜ and not on data, derived during processing, of the sequential data series xₜ₊₁ to xₜ₊ₕ.

The diagram depicted in FIG. 4 schematically shows processing in a VRNN to predict two future items of data x₃, x₄ of a sequential data series x₁ to x₄ on the basis of two known items of data x₁, x₂ of the sequential data series x₁ to x₄.

During processing of the known data x₁, x₂ of the sequential data series x₁ to x₄, the probability distribution over the latent variables zᵢ, i.e. those of the prior probability (prior) and those of the posterior probability distribution (inference), are in each case dependent on the (known) data xᵢ of the sequential data series x₁ to x₄ with i<3.

To predict the data xᵢ of the future time steps i with i>t, only the posterior probability distribution (inference) is dependent on predicted latent variables z₃, z₄, whereas the prior probability distribution (prior) is not.

In the depiction, this is depicted by the downward branch.

The part above the hidden states hᵢ corresponds substantially to processing according to FIG. 4. The part below the hidden states hᵢ represents the influence of the present invention on processing of the data xᵢ of the sequential data series x₁ to x₄ to predict data of the future time steps i with i>t using corresponding artificial neural networks, such as for example VRNN.

The “likelihood” fraction of the estimate of the lower boundary (ELBO) is calculated from these probability distributions and the future data x₃, x₄ of the sequential data series x₁ to x₄. In the lower branch, the latent variables z′3, z′4 are determined independently of the future data x3, x4 of the sequential data series. A simple way of implementing this is to calculate the data of the sequential data series xᵢ on the basis of samples of the prior probability distribution (prior) of the latent variables zᵢ, take samples from this probability distribution and feed these samples into the hidden states h′ᵢ of the RNN. The hidden state h₂, which summarizes the past, represented in x₁, x₂, z₁, z₂, may be used to obtain the latent distribution over z₃, but thereafter “parallel” hidden states zᵢ, z′ᵢ have to be constructed which do not include any information relating to the future data x₃, x₄ of the sequential data series x₁ to x₄, but instead feed in generated values of x′₃ and x′₄ to update the parallel hidden states h′ᵢ.

Although h′ᵢ over zᵢ data could be indirectly dependent on xi, this is not the case, since the KL divergence is used for zᵢ. Therefore zᵢ contains virtually no appreciable information about xᵢ.

Information from zᵢ about the future has, due to the application of KL divergence, to be identical to the information about the future conditional on the past.

In this way, the lower paths in the computational flow of the training time correspond better with the computational flow of the inference time, with the exception that the samples of the latent variables in the RNN are fed in from the posterior probability distribution (inference) and not from the prior probability distribution.

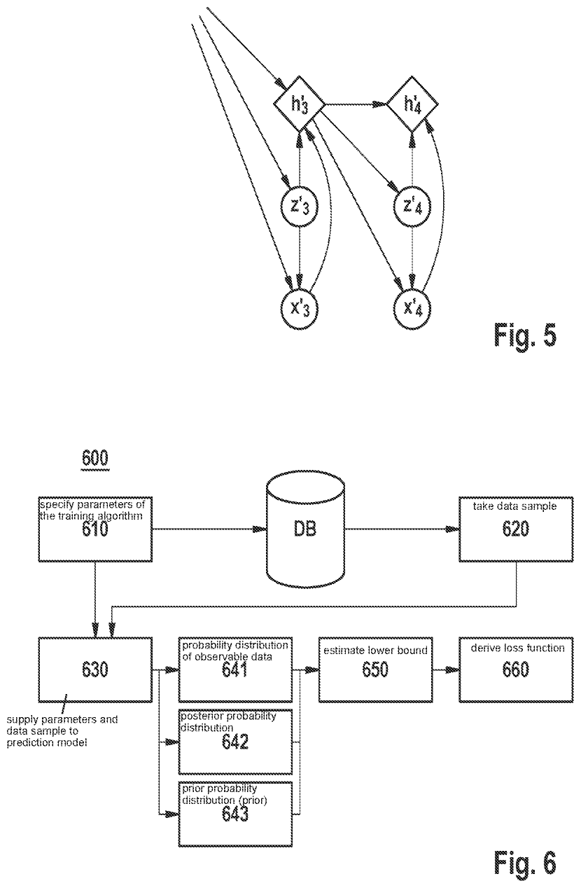

FIG. 5 shows a portion of the processing diagram shown in FIG. 4.

This portion shows an alternative embodiment for the lower processing branch. The alternative consists on the one hand in the fact that no information of the upper branch is fed into the lower branch. The alternative further consists in feeding the earlier samples into the RNN also during training, which is a further entirely valid approach which corresponds perfectly to the computational flow of the inference time.

FIG. 6 shows a flowchart of an iteration of an embodiment of the training method according to the present invention.

In step 610, parameters of the training algorithm are specified.

These parameters include, inter alia, the prediction horizon h and the size or length t of the (known) past data set.

These data are forwarded on the one hand to a training data set database DB and on the other to step 630.

In step 620, a data sample consisting of ground truth data, which represent the (known) past time steps x₁ to xₜ and the data to be predicted of the future time steps xₜ₊ᵢ to xₜ₊ₕ, is taken from the training data set database DB according to the parameters.

The parameters and the data sample are supplied in step 630 to the prediction model, for example a VRNN. This models derives three probability distributions therefrom:
1) in step 641, the probability distribution of the observable data to be predicted over xₜ₊ᵢ to Xₜ₊ₕ as a function of the known observable data x₁ to xₜ and the latent variables z₁ to Zₜ₊ₕ, p(xₜ₊₁ . . . xₜ₊ₕ|x_{1 . . . t}, z_{1 . . . t+h);}
2) in step 642, the posterior probability distribution (inference) over the latent variables z₁ to zₜ₊ₕ as a function of the provided data set x₁ to xₜ₊ₕ;
3) in step 643, the prior probability distribution (prior) over the latent variables z₁ to zₜ₊ₕ as a function of the known data of the past time step x₁ to xₜ.

Then, in step 650, the lower bound is estimated in order to derive the loss function in step 660.

From the derived loss function, it is then possible, in a part which is not shown, for example by back propagation, to adapt the parameters of the artificial neural network, for example of the VRNN.

1-10. (canceled)

11. A method for training an artificial neural network to predict future sequential time series (xt+1 to xt+h) in time steps (t+1 to t+h) as a function of past sequential time series (xl to xt) to control an engineering system, using training data sets (xl to xt+h), the method comprising:
adapting a parameter of the artificial neural network as a function of a loss function, the loss function including a first tern, which includes an estimate of a. lower bound (ELBO) of distances between a prior probability distribution (prior) over at least one latent variable and a posterior probability distribution (inference) over the at least one latent variable;
wherein the prior probability distribution (prior) is independent of future sequential time series (xt+1 to xt+h).

12. The method as recited in claim 11, wherein the artificial neural e work is a Bayesian neural network.

13. The method The method as recited in claim 11, wherein the artificial neural network is a Virtual Recurrent Neural Network (VRNN).

14. The method as recited in claim 11, wherein the prior probability distribution (prior) is not dependent on the future sequential time series (xt+1 to xt+h).

15. The method as recited in claim 11, wherein the lover bound (ELBO) iis estimated according to following rule, using the loss function:
log p(x_{t+1 . . . t+h}|x_{1 . . . t})
≥ [symbol] _{q(z}_{_{1 . . . t+h}}_{|x}_{_{1 . . . t+h)[log}} p(x_{t+1 . . . t+h}|x_{1 . . . t}, z_{1 . . . t+h)]}
−D_{KL}(q(z_{1 . . . t+h}|x_{1 . . . t+h})||p(z_{1 . . . t+h}|x_{1 . . . t}))
, wherein:
p(x_{+1 . . . t+h}|x₁ . . . t) represents a target probability distribution over observable variables of the future time steps up to a horizon h, x_{t+1 . . . t+h}, conditional on the observable variables of past time steps x₁ . . . t,
q(z₁ . . . t+h|x₁ . . . t+h) represents the posterior probability distribution (inference) over latent variables, z₁ . . . t+h, over an entire observation period including for the past time step, 1 . . . t and the future time steps up to a horizon h, t+1 . . . t+h conditional on the observable variables over the entire observation period x₁ . . . t+h,
p(x_{t+1 . . . t+h}|x_{1 . . . t}, z₁ . . . t+h) represents a generation including a probability distribution over the observable variables of the filture time steps up to a horizon h, xₜ+1 . . . t+h, conditional on the observable variables of the past time steps x₁ . . . t and the latent variables, z₁ . . . t+h, over the entire observation period, t+1 . . . t+h and
p(z_{1 . . . t+h}|x_{1 . . . h}) represents the probability distribution (prior) over the latent variables, z₁ . . . t+h, conditional on the observable variables of the past time steps: x₁ . . . t.

16. A non-transitory machine-readable storage medium on which is stored a computer program for training an artificial neural network to predict future sequential time series (xt+1 to xt+h) in time steps (t+l to t+h) as a function of past sequential time series (xl to xt) to control an engineering system, using training data sets (x1 to xt+h), the computer program, when executed by a computer, causing the computer to perform the following:
adapting a parameter of the artificial neural network as a function of a loss function, the loss function including a first term, which includes an estimate of a lower bound (ELBO) of distances between a prior probability distribution (prior) over at least one latent variable and a posterior probability distribution (inference) over the at least one latent variable;
wherein the prior probability distribution (prior) is independent of future sequential time series (xt+1 to xt+h).

17. An artificial neural network including Bayesian neural network, the artificial neural network being trained to predict future sequential time series (xt+1 to xt+h) in time steps (t+1 to t+h) as a function of past sequential time series (xl to xt) to control an engineering system, using training data sets (xl to xt+h), the artificial neural network being trained by:
adapting a parameter of the artificial neural network as a function of a loss function, the loss function including a first term, which includes an estimate of a lower bound (ELBO) of distances between a prior probability distribution (prior) over at least one latent variable and a posterior probability distribution (inference) over the at least one latent variable;
wherein the prior probability distribution (prior) is independent of future sequential time series (xt+1 to xt+h).

18. A method of using an artificial neural network including a Bayesian neural network, the method comprising:
providing a trained artificial neural network, the artificial neural network being trained to predict future sequential time series (xt+1 to xt+h) in time steps (t+1 to t+h) as a function of past sequential time series (xl to xt) to control an engineering system, using training data sets (xl to xt+h), by:
adapting a parameter of the artificial neural network as a function of a loss function, the loss function including a first term, which includes an estimate of a lower bound (ELBO) of distances between a prior probability distribution (prior) over at least one latent variable and a posterior probability distribution (inference) over the at least one latent variable,
wherein the prior probability distribution (prior) is independent of future sequential time series (xt+1 to xt+h); and
controlling, using the trained artificial neural network, the engineering system, the engineering system including a robot or a vehicle or a tool or a machine tool.

19. A non-transitory machine-readable storage medium on which is stored a computer program for using an artificial neural network including a Bayesian neural network, the computer program, when executed by a computer, causing the computer to perform the following:
providing a trained artificial neural network, the artificial neural network being trained to predict future sequential time series (xt+1 to xt+h) in time steps (t+1 to t+h) as a function of past sequential time series (xl to xt) to control an engineering system, using training data sets (xl to xt+h), by:
adapting a parameter of the artificial neural network as a function of a loss function, the loss function including a first term, which includes an estimate of a lower bound (ELBO) of distances between a prior probability distribution (prior) over at least one latent variable and a posterior probability distribution (inference) over the at least one latent variable;
wherein the prior probability distribution (prior) is independent of future sequential time series (xt+1 to xt+h); and
controlling, using the trained artificial neural network, the engineering system, the engineering system including a robot or a vehicle or a tool or a machine tool.

20. A device for controlling an engineering system using an artificial neural network including a Bayesian neural network, the neural network being trained to predict future sequential time series (xt+1 to xt+h) in time steps (t+1 to t+h) as a function of past sequential time series (xl to xt) to control an engineering system, using training data sets (xl to xt+h), the artificial neural network being trained by:
adapting a parameter of the artificial neural network as a function of a loss function, the loss function including a first term, which includes an estimate of a lower bound (ELBO) of distances between a prior probability distribution (prior) over at least one latent variable and a posterior probability distribution (inference) over the at least one latent variable;
wherein the prior probability distribution (prior) is independent of future sequential time series (xt+1 to xt+h);
wherein the device is configured to use the trained artificial neural network to control the engineering system, the engineering system including a robot or a vehicle or a tool or a machine tool.
